(19) United States
(12) Patent Application Publication
(10) Pub. No.: US 2026/0083640 A1
(43) Pub. Date: Mar. 26, 2026

(54) Method for Operating a Feeding System for Feeding a Patient with a Liquid Feed

(71) Applicant: MEDELA HOLDING AG, Baar (CH)

(72) Inventors: Natalie Stevens, Baar (CH); Daniel McGowan, Baar (CH); David Y. Cho, Arlington Heights, IL (US); Andy Giles, Crystal Lake, IL (US)

(21) Appl. No.: 18/895,658

(22) Filed: Sep. 25, 2024

(51) Int. Cl. A61J 15/00

(52) U.S. Cl. CPC A61J 15/0011; A61J 15/008

(57) ABSTRACT

The present invention relates to a method for operating a feeding system for feeding a patient with a liquid feed, which liquid feed is stored in a reservoir, which reservoir is fluidically connected to a tube which has an inlet end for receiving the liquid feed from the reservoir and an outlet end for dispensing the liquid feed toward the patient and is adapted to convey said liquid feed contained in the reservoir to the patient. In order to reduce the volume of feed contained in the feeding system to be discharged after stopping the pumping device, the present invention provides a method and a feeding system allowing a purging phase ordered by the controller assigned to the pumping device, in which the supply of liquid from the reservoir is stopped and a purging fluid drives liquid feed contained in the tube toward the outlet end and wherein the controller stops the introduction of the purging fluid at the end of the purging phase.

The invention relates to a method for operating a feeding system for feeding a patient with a liquid feed.

### BACKGROUND OF THE INVENTION

The present invention refers to Neonatal Enteral Feeding for NICU (Neonatal Intensive Care Unit) applications. Patients (newborn infants) born prematurely and under other circumstances have not developed the ability to feed orally, because this requires a suck, swallow, breath mechanism that is developed very late in the womb. Therefore premature patient have to be supported for feeding until they are able to feed autonomously.

Premature patients need to be fed with enteral nutritional feed, such as mom milk based or milk containing mixture; the feed has to be collected, stored and maintained in a safe way and periodically (e.g. every 3 hours) fed to the patient. This is done in NICU hospital wards.

In particular, milk is collected by the mom (e.g. at home) and is brought to the hospital (NICU hospital ward). At the hospital the milk is stored and when required a feed is prepared with the milk for being fed to the patient. Preparation of the feed may include mixing different milk collected at different times from one and the same mom or mixing milk collected from different moms and in addition usually preparation also includes the addition of fortification, i.e. addition of nutrients, for the patient to receive the required nutrient substances also in small volume of feed (because the patient is a premature newborn!). The feed is fed to the patient via a syringe/pump system.

The syringe is filled with the feed, pre-warmed to body temperature and is then connected to an enteral feeding pump. This pump drives the syringe to deliver the feed to the patient at a controlled rate.

The milk collected by the mom is of great value. Thus, great care shall be applied to use as much of the milk collected from the mom.

### PROBLEM TO BE SOLVED

The present invention aims to provide a solution which reduces the amount of liquid feed which needs to be discharged in the course of batch feeding of a patient.

### SUMMARY OF THE INVENTION

The present invention provides a method for operating a feeding system for feeding a patient with a liquid feed. Respective liquid feed is stored in a reservoir, which reservoir is fluidically connected to a tube. Respective tube has an inlet end for receiving the liquid feed from the reservoir and an outlet end for dispensing the liquid feed toward the patient. The outlet end usually is the final end of the feeding system which final end delivers the liquid feed to the patient and may be introduced into the esophagus of the patient. Respective tube is adapted to convey said liquid feed contained in the reservoir to the patient. For the inventive method, a pumping device is provided adapted to convey the fluid feed from the reservoir through the tube to the patient. In other words, the pumping device forces the liquid feed toward the patient.

In the inventive method and at the end of the feeding, in particular at the end of feeding the batch, a controller orders a purging phase. In this purging phase, the supply of liquid feed from the reservoir is stopped. In other words, no liquid feed is taken from the reservoir for feeding the patient. Instead, a purging fluid is introduced into the tube. This purging fluid drives liquid feed in the tube toward the outlet end. Thus, the purging fluid replaces the valuable liquid feed within the tube and advances the liquid feed toward the outlet end.

The end of the purging phase is provided by the controller stopping the introduction of the purging fluid into the feeding system. Thus, advancing of the purging fluid toward the patient is stopped. Preferably, the purging phase is stopped before the purging fluid is discharged through the outlet end.

Evidently, almost all liquid feed contained in respective tube by the purging fluid being introduced into the tube can be used for feeding the patient. No considerable amount of liquid feed needs to be discharged in the course of batch feeding of a patient.

According to a first aspect the controller orders a purging phase in which the supply of the liquid feed from the reservoir is stopped and a purging fluid is introduced into the tube via a purge inlet, which purging fluid drives liquid feed contained in the tube toward the outlet end. The controller determines the volume of purging fluid to be pumped through the tube on the basis of
a prescribed volume of feed to be supplied to the patient and
a feeding volume of feed supplied to the patient during feeding preceding the purging phase, and
a purging volume essentially corresponding to the volume of the tube or the volume of the liquid feed contained in the feeding system downstream of the purge inlet,
so that the feeding volume and the purging volume correspond to the prescribed volume.

As far as the present application refers to “volume”, respective referral can likewise be understood as meaning “amount”.

Preferably, the pumping device is a volumetric pumping device and controller further determines the purging volume on the basis of the volumetric yield of the pumping device (10). More preferably the pumping device can deliver basic volumes of fluid and the volumetric yield of the pumping device is determined on the basis of the number of basic volumes deliverable by the pumping device.

An example of such a pumping device may be a pump with a reciprocating pumping means, the movement thereof cyclically expands and reduces the volume of a pumping chamber. The difference between the maximum volume and the minimum volume of such pumping chamber may correspond to the basic volume delivered by the pumping device. The volumetric yield of the pumping device may be obtained by multiplying the basic volume with the number of reciprocating cycles. As the controller regularly controls the pumping device, the controller shall know the number of cycles and/or the basic volume. Alternatively, the basic volume may have been stored in particular in case each cycle will provide a constant basic volume due to the structural design of the pumping chamber and/or the reciprocating pumping means.

Accordingly, and according to this preferred embodiment, the controller may calculate the volumetric yield of the pumping device and set the purging volume to correspond with a specific number of cycles multiplied by the basic volume.

Preferably, the controller stops purging as soon as the determined volume of purging fluid or the prescribed volume has been introduced into the tube.

The purging fluid can be introduced into the fluid at an inlet end of the tube. Air or sterile water may be used as the purging fluid. In order to yield a greater amount of liquid feed contained in the feeding system, the purging fluid may as well be introduced into the pumping device, in particular upstream of a pumping chamber of said pumping device.

According to a preferred embodiment of the present invention, at the beginning of the purging phase the controller controls a purge valve to shut the fluid connection between the reservoir and the outlet end. The controller furthermore orders to bring a purge inlet in fluid communication with the tube in order to allow the purging fluid to be introduced into the tube downstream of the purge valve for driving the volume of the liquid feed contained in the feeding system toward the outlet end of the tube. Usually, the purging fluid will drive the residual volume of liquid feed toward the outlet end of the tube. Preferably, the controller stops feed delivery before starting purging.

As mentioned before, such purge valve may be provided within the pumping device and upstream of the pumping chamber and thus not necessarily at the inlet end of the tube. The purge valve may be even arranged just downstream of the reservoir in order to purge and thereby yield the volume of liquid feed which has left the reservoir.

According to a preferred embodiment of the present invention, the controller may determine the end of the purging phase on the basis of the volumetric yield of the pumping device. Such volumetric yield of the pumping device may e.g. be calculated by the number of strokes multiplied by the stroke volume of the pumping device. In this preferred embodiment, the volume of liquid contained in the feeding device downstream of the purge inlet is a known figure. With this volume and the volumetric yield, the controller can determine e.g. the number of strokes of the pump required for providing an overall volumetric yield by those numbers of strokes to correspond to the volume of liquid feed contained in the feeding device downstream of the purge inlet.

As a further preferred embodiment, the controller can determine the volume of the liquid feed contained in the feeding system downstream of the purge inlet on the basis of information relating to the volume of the tube and/or metering components of the feeding system. This information is preferably stored in a memory of the controller, which may be the case if the feeding system uses a standard tube for dispensing the liquid feed. In case different components are assembled for making the feeding system, each component may be supplied with information on the volume of respective component including the tube and/or the pumping device. Respective information may be read into the memory when setting up the feeding system. For this, the controller may be coupled with an interface, which may be a user interface on the controller of the system or a wireless interface. Specific fluid volumes of specific components may likewise be entered automatically by reading a bar code on the packaging of the respective component. Thus, respective preferred embodiment of the present invention will allow use of different components and/or allow determination of the volume of liquid feed contained in the feeding device via product information of the at least one tube and/or the pumping device used in combination with the tube. A metering component in this context can be any component part, in particular a pumping device, which is positioned downstream of the purge inlet and/or provides respective purge inlet. In the latter case, the volume of the metering component downstream of the purge inlet usually is the decisive information on the volume to be entered into the memory.

The controller is able to purge all liquid feed from the tube so that the liquid feed is fed to the patient and is not lost. At the same time, the purging is preferably stopped as soon as the liquid feed is completely purged from the tube, so that the patient is only fed with the liquid feed being purged but he doesn't receive any purging fluid. The information on the volumetric yield of the pumping device and the volume of liquid feed contained in the feeding system downstream of the purge inlet allow the controller to calculate the volume of purging fluid to be pumped through the tube.

Such preferred embodiment is particularly valuable, if a variety of tube components is used, wherein information on the volume of each tube component is stored in the memory of the controller. In this preferred embodiment, information on the volume of the selected tube component is used for determining the volume of the liquid feed contained in the feeding system. This information on the volume is a result of entry of data identifying the selected tube component. With the identification of the selected tube component, the memory will look up the fluid volume of the respective component and take respective volume into account when determining the end of the purging phase, i.e. the corresponding volume of purging fluid to be introduced for purging at least in part the feeding system.

The end of the purging phase may as well alternatively or in addition as a safeguard be determined on the basis of a signal of a purge sensor assigned to the outlet end of the tube. This purge sensor is adapted to detect the presence of the purge fluid within the tube. The sensor may be an optical, sonic or temperature sensor or other kind of sensor. The sensor is in particular sensitive in case a gaseous purging fluid is used for purging. The purging fluid may preferably be air, which air will provide a clearly noticeable signal when passing the purge sensor driving liquid feed out of the tube and pass the sensor. The purge sensor may be arranged in close vicinity or at the outlet end of the tube.

According to a parallel aspect of the present invention, a feeding system is provided for feeding a patient, which feeding system is adapted to allow purging of the liquid feed as discussed in further detail above.

The purge valve preferably is a three-way-purge valve which is adapted to be moved into a pumping position, in which the reservoir is in fluid communication with the outlet end and a purging position, in which the purge inlet is in fluid communication with the outlet end. With such three-way-valve, the pumping and the purging position can only be provided alternatively.

According to a further preferred embodiment of the present invention, the pumping device comprises a pumping cartridge. This pumping cartridge has a cartridge housing having a pumping chamber, an inlet port and an outlet port. Each of said ports is in fluid communication with the pumping chamber and a pumping channel provided within the cartridge housing between the inlet port and the outlet port. Such pumping cartridge may be a disposable part of the pumping system to be connected with a drive unit comprising actuators and possibly also a motor for varying the volume of the pumping chamber and thereby pump the liquid feed through the pumping chamber. The pumping cartridge may be permanently connected to a reservoir via a tube. The cartridge device according to this preferred embodiment further comprises the purge inlet and a purge chamber arranged upstream of the pumping chamber and provided with the purge valve.

This preferred embodiment of the present invention allows to provide the pumping chamber as well as the purge valve in one unit which forms part of the feeding device, which unit may be discharged after use. Preferably, the pumping cartridge does not have any actuators. Instead, the control and the driving actuators and at least one motor driving the same required for effecting pumping are purely contained in the drive unit.

Air as the purging liquid not only provides an advantage for securely and easily detecting the end of the purging phase. Air can also be easily introduced into the feeding system from ambient by the provision of an air inlet which is openable and closeable by the purge valve. In this case preferably a biological filter is provided, to prevent ambient contamination of the feeding system.

### BRIEF DESCRIPTION OF THE DRAWINGS

The present invention will be better understood with reference to the detailed description taken in combination with the drawings in which

FIG. 1 is a schematic view of a feeding system;

FIG. 2 is a perspective top view of the pumping device of the feeding system of FIG. 1;

FIG. 3 is a perspective top view of the pumping device of FIG. 2 from the other side;

FIG. 4 is a first sectional view along line IV-IV according to FIG. 2;

FIG. 5 is a sectional view along lines V-V example finding in particular a purge valve;

FIG. 6 is a top view of the purge valve according to FIG. 5 in a pumping position;

FIG. 7 is a perspective view in accordance with FIG. 6 for the purge valve in a purging position;

FIG. 8 is a cross-sectional view along line VIII-VIII in FIG. 2 exemplifying an occlusion sensor;

FIGS. 9a, b show a schematic view of an alternate occlusion sensor;

FIG. 10 shows a schematic cross sectional view of the drive unit of the pumping device of FIGS. 2, 3;

FIG. 11 shows a top view of a drive interface of the drive unit of FIG. 10;

FIG. 12 shows a perspective partially exploded view of the actuators of the drive unit of FIGS. 10, 11 and the motors provided for operating those actuators;

FIG. 13 schematically exemplifies the controller of the feeding system of FIG. 1;

FIG. 14 a graph on the pressure signal of the occlusion sensor.

### DETAILED DESCRIPTION OF THE PREFERRED EMBODIMENTS

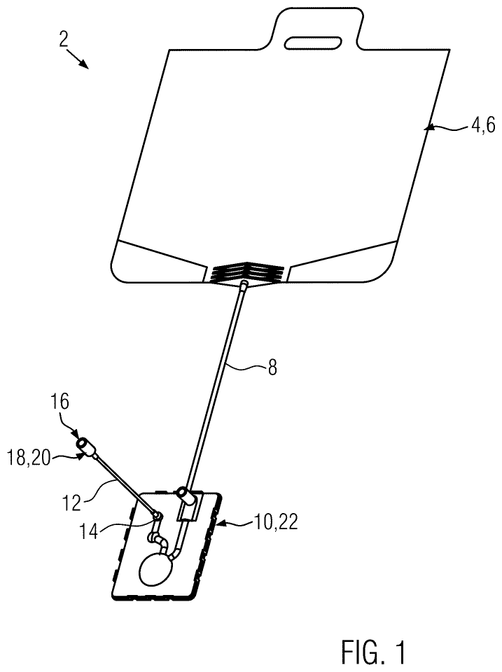

Referring to the drawings, there is shown in FIG. 1, a schematic of the feeding system of the present invention generally identified with reference number 2 and comprising a reservoir 4 in form of a flexible bag 6, the outlet side thereof being connected to a supply tube 8 which provides a fluid connection between the reservoir 4 and a pumping device 10. Downstream of said pumping device there is provided a discharge tube 12, which has an inlet end 14 and an outlet end 16.

In the shown embodiment, the reservoir 4 contains liquid feed for feeding a patient. Accordingly, the inlet end 14 receives said liquid feed from the reservoir 4 whereas the outlet end of the discharged tube 12 is adapted to discharge the liquid feed, preferably by introducing the discharge tube 12 and thus the liquid feed directly into the patient.

Reference number 18 identifies a purge sensor assigned to the outlet end of the discharge tube 12. Respective purge sensor 18 is provided at or in close vicinity to the outlet end 16. Reference number 20 identifies a priming sensor at or in close vicinity to the outlet end 16. The purge sensor 18 and the priming sensor 20 may be embodied in a single sensor arrangement.

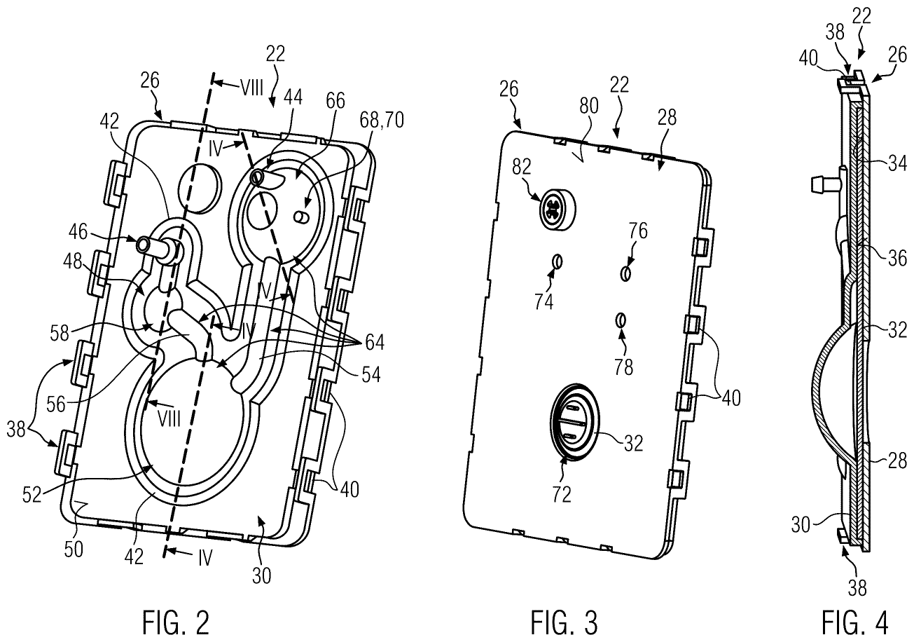

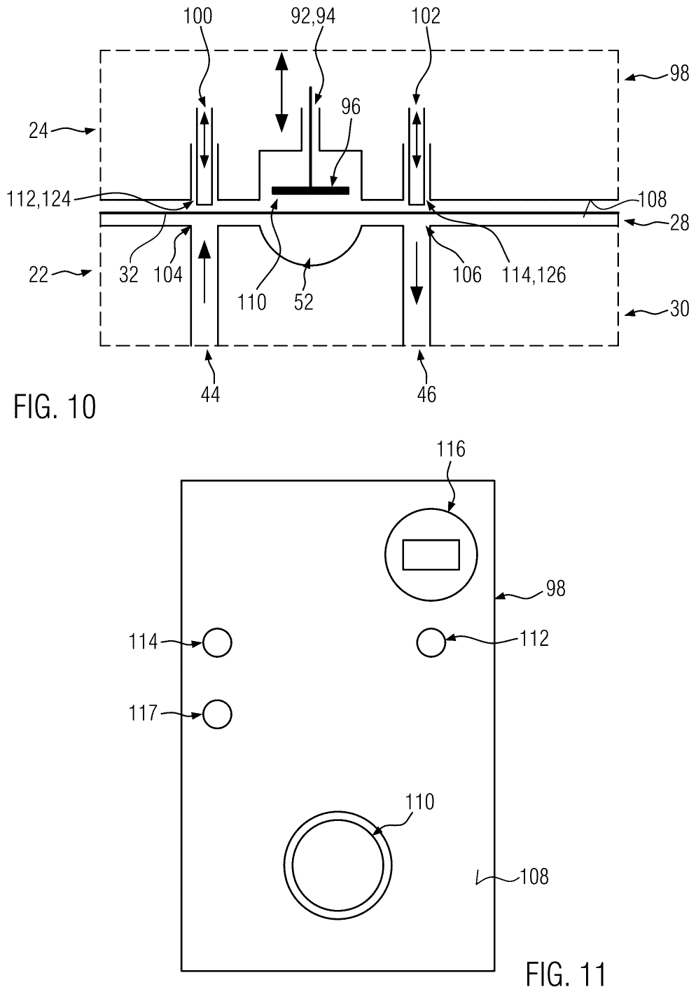

FIGS. 2 to 4 exemplify details of a pumping cartridge 22 of the pumping device 10 of FIG. 1. As schematically shown in FIG. 10 respective pumping cartridge 22 is adapted to be releasably connected to a drive unit 24. In other words, the pumping cartridge 22 provides the disposable part of the pumping device 10, whereas the drive unit 24 is intended for being reused plural times. The feeding system 2 may have a reservoir 4 like e.g. a bag of liquid feed to be fed to the patient. The pumping cartridge 22 may be connected via the tube 8 to the reservoir, so that after use reservoir, tube 8 and pumping cartridge 22 are dispensed with, while the drive unit 24 is consecutively releasably connected to multiple of the pumping cartridges.

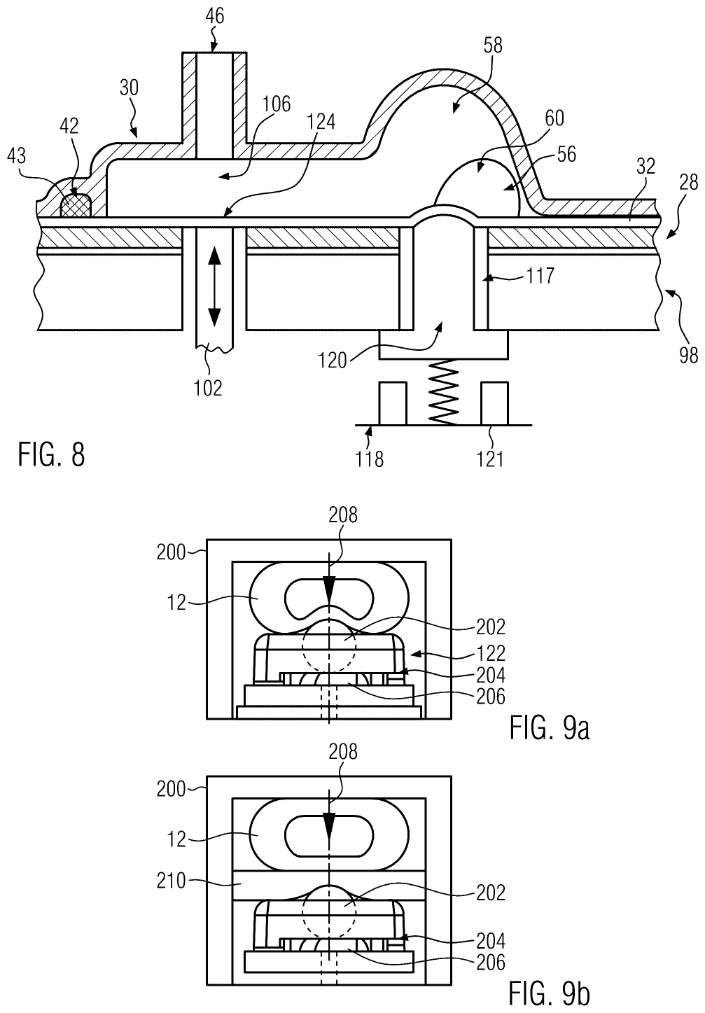

The pumping cartridge 22 has a cartridge housing 26 being composed of total three components i.e. a first housing element 28, a second housing element 30 and a membrane 32, which membrane 32 is sandwiched between the first and the second housing elements 28, 30, respectively. As shown in FIG. 4, the membrane 32 abuts a first sandwiching surface of the first housing element 28 and a second sandwiching surface 36 of the second housing element 30. As evident from FIG. 4, those inner sandwiching surfaces 34, 36 are each completely flat. Around the outer circumference of at least one of the first and the second housing elements 28, 30 there are provided snapping elements 4 connecting the two housing elements 28, 30 with each other with the membrane 32 sealed between those two housing elements 28, 30 respectively. In the specific embodiment, the first housing element 28 has U-shaped receptacles 38 receiving and encompassing bosses 40 at the outer circumference of the second housing element 30. The membrane 32 may be sealed between the two inner sandwiching surfaces 34, 36 by connection of the two housing elements 28, 30 respectively and this just be sandwiching. In the present embodiment, the second housing element 30 is provided with a sealing grove 42, which contains sealant 43 (see FIG. 8) for sealing the membrane 32 against the second housing element.

As evident from FIG. 2, an inlet port 44 and an outlet port 46 are provided within a sealed membrane area 48 surrounded by the sealing grove 42. The inlet port 44 and an outlet port 46 project perpendicular from a generally flat outer surface 50 of the second housing element 30. Reference number 52 identifies a pumping chamber connected to the inlet port 44 by an upstream pumping channel section 54 and connected to the outlet port 46 by a downstream pumping channel section 56, which is interrupted by a occlusion sensor chamber 58 providing an occlusion sensor location 60.

The upstream and downstream pumping channel sections 54; 56 define a pumping channel 62. The pumping channel 62, the occlusion sensor chamber 58 and the pumping chamber 52 are each provided by contours projecting the flat outer surface 50 of the second housing element 30.

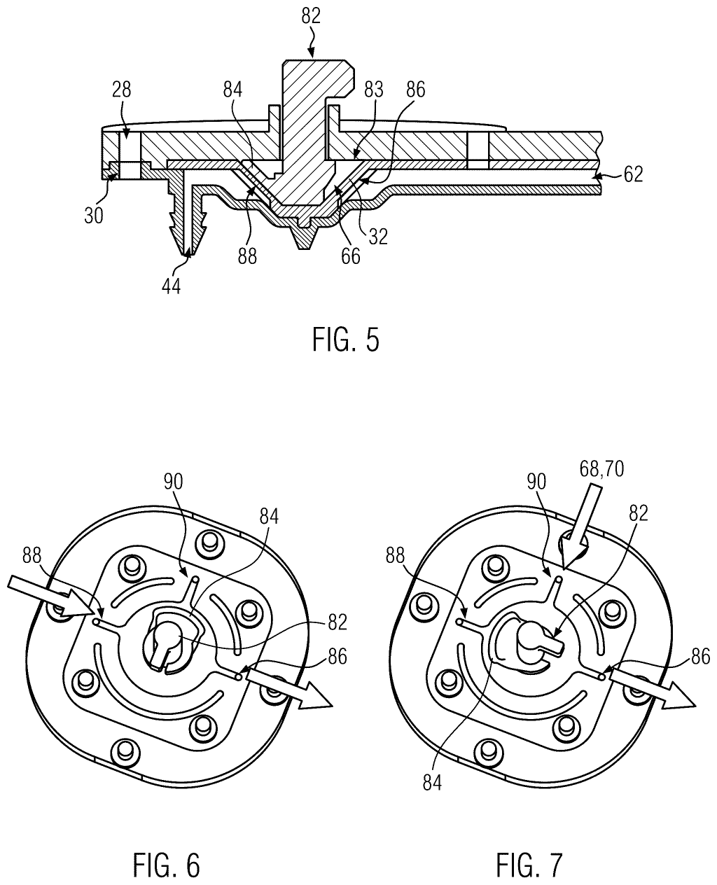

The inlet port 44 projects from a purge chamber 66, the functionality thereof, being further described by referring to FIGS. 5-7. On the outer circumference of said purge chamber 66 there is provided a purge inlet 68 in form of an air inlet 70.

As shown in FIG. 3, the first sandwiching surface has a pumping actuator opening 72, an inlet valve actuator opening 74, an outlet valve actuator opening 76 and an occlusion sensor opening 78. Those openings 72-78 are covered by the membrane 32. As the membrane 32 is provided between the two housing elements 28, 30 and sealingly secured to the second housing element 30, the membrane 32 covers the pumping channel 62, the pumping chamber 52 and the occlusion sensor chamber 58; see FIGS. 4 and 8. As further evident from FIG. 5, the membrane 32 is likewise projected into the frustoconical purge chamber 66.

FIG. 3 shows the first housing element 28 with its flat cartridge interface 80, in which the above-mentioned openings 72-78 are recessed and sealed on the inner side by the membrane 32. The cartridge interface 80 is projected by a purge valve actuator 82, which will be described hereinafter in particular by referring to FIGS. 5-7.

As evident from FIG. 5, the purge valve actuator 82 has a valve arm 84 formed in an oblique way in accordance with the inner circumferential oblique surface of the frustoconical purge chamber 66. The purge chamber 66 has a purge chamber outlet opening 86, a purge chamber feed inlet opening 88, both being shown in FIG. 5 and a purge chamber purge inlet opening 90, which is essentially provided in accordance with the purge chamber feed inlet opening 88 but arranged at a 90° offset in clockwise direction as seen in FIGS. 6 and 7, respectively.

In FIG. 5, the valve arm 84 presses the membrane 32 against the purge chamber feed inlet opening 88 thereby closing this opening 88. Due to the flexibility of the membrane 32 following this movement imposed by the valve arm 84, the purge chamber purge inlet opening 90 is open in the position of the purge valve actuator 82 as shown in FIGS. 5 and 7. This position is a purge position, in which the purge inlet 68 is via the purge chamber 66 in fluid communication with the purge chamber outlet opening 86 and thus with the pumping channel 62 and thus the pumping chamber 52. FIG. 6 shows the pumping position of the purge valve actuator 82, in which the purge chamber feed inlet opening 88 is open and the purge chamber purge inlet opening 90 is closed by the valve arm 84 in combination with the membrane 32. Thus, the inlet port 44 is in fluid communication with the pumping chamber 52.

FIG. 10 is a schematic view showing the pumping cartridge 22 and the drive unit 24 in a simplified sectional view. In the middle of FIG. 10, the pumping chamber 52 can be seen to be covered by the membrane 32. Opposite to the pumping chamber 52 there is provided a pumping actuator 92 in form of a piston 94 which moves in a reciprocating fashion and thus along with the membrane 32 provides volume varying means 94 for varying the effective volume within the pumping chamber 52. The reciprocating movement of the piston 94 is shown to be guided by a drive unit housing 98, which likewise guides a reciprocating movement of an inlet valve actuator 100 and an outlet valve actuator 102. Opposite to the inlet valve actuator 100 the cartridge housing, specifically the second housing part 30 provides an inlet valve location 104. Reference number 106 identifies an outlet valve location provided by the second housing part 30.

As can be seen from FIGS. 10 and 11 in combination, the drive unit housing 98 provides a drive interface 108 having plural openings, i.e. a drive side pumping actuator opening 110 receiving and guiding the pumping actuator 92, a drive side inlet valve actuator opening 112 and a drive side outlet valve actuator opening 114, each receiving and guiding one of the inlet valve actuator 100 and outlet valve actuator 102, respectively. Reference number 116 in FIG. 8 identifies a drive side occlusion sensor opening, which receives and guides an occlusion sensor identified in total with reference number 118 in FIG. 8. This occlusion sensor 118 contains a sensor contact element 120 biased towards the membrane 32 and cooperating with a sensor die 121. Due to the pretension of the sensor contact element 120 towards the occlusion sensor chamber 58, the membrane 32 bulges inwardly into said occlusion sensor chamber 58.

As already mentioned above, the valve actuators 100, 102 are adapted to move beyond the drive interface 108 and into the cartridge housing 26.

Preferably and exemplified in FIG. 8, the inlet and/or outlet valve location is provided by the inlet and outlet port 44, 46, respectively. In such an embodiment, the forward free end of the inlet valve actuator 100 cooperates with the opening of the inlet port 44 and the outlet valve actuator 102 cooperates with the opening of the outlet port 46 for opening and closing an inlet valve 122 or an outlet valve identified in FIG. 8 with reference number 124.

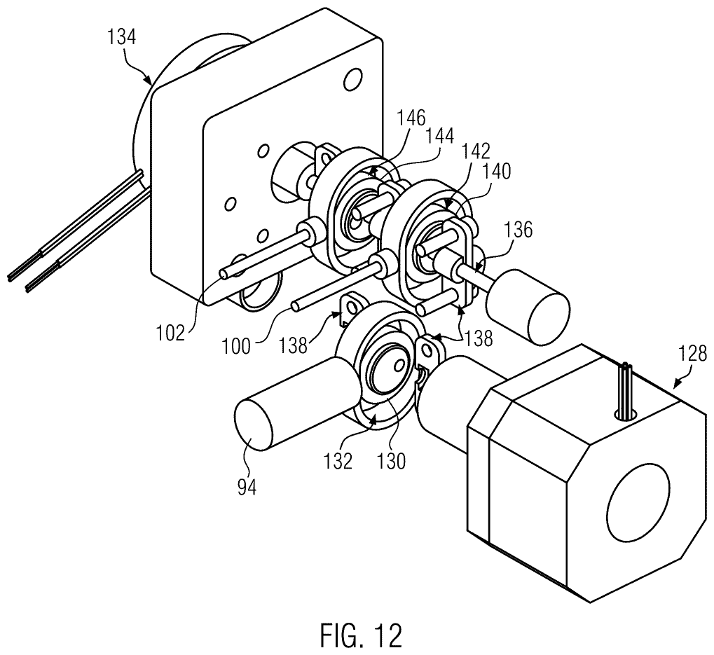

FIG. 12 is a schematic of the drive system of the drive unit 24. In this specific embodiment, a first motor 126 is provided rotatably driving a piston cam 128, which piston cam 128 is received within a piston cam receptacle 130 connected to the piston 94.

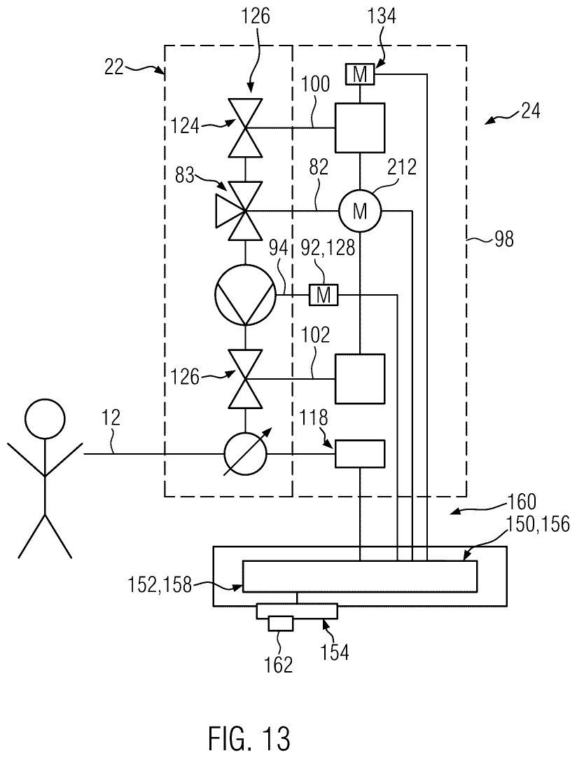

A second motor 132 rotatably drives a shaft 134 supported by bearings 136, which shaft 134 drives an inlet valve cam 138 received within an inlet valve cam receptacle 140 connected to the inlet valve actuator 100. In a respective fashion, an outlet valve cam 142 connected to the shaft 134 is received within an outlet valve cam receptacle 144, which is connected to the outlet valve actuator 102. The motors 126, 132 are synchronized by a controller identified with reference number 150 in FIG. 13 to provide a specific operation in which the inlet valve 122 is opened to permit liquid feed to flow into the pumping chamber 52. After that the inlet valve 122 is shut off or closed by advancing the inlet valve actuator 100 towards a mouth of the inlet port 44 which by interdisposing the flexible material of the membrane 32 is completely sealed by the membrane 32. Then the outlet valve 124 is opened while compressing the pumping chamber 52 by means of the piston 95 and the membrane 32.

Dislocation of the sensor contact element 120 of FIG. 8 towards the drive unit housing 98 is sensed by the occlusion sensor 118 and processed in the controller 150 as an indication of occlusion downstream of the occlusion sensor 118

While FIG. 12 shows an embodiment with two motors, it is evident that a single motor can drive a sample shaft 134 being connected to the three cams 128, 138, 142 moving the piston 94 and the inlet and outlet valve actuators 100, 102, respectively.

While the above description relates to an occlusion sensor 118 provided by the pumping cartridge 22, such occlusion sensor may likewise be provided separately and cooperate with the discharged tube 12 as exemplified in FIGS. 9a, 9b. FIG. 9a shows an occlusion sensor in which the sensors switch 122 is surrounded by a U-shaped sensor clamp 200, which forces the discharged tube 12 against the sensor switch 122. In this embodiment, the sensor switch 122 comprises a sphere 202 contained in a sensor housing 204, housing a sensor die 206. With increasing internal pressure within the lumen of the discharge tube 12, the sphere 202 will be forced in the direction of arrow 208 thereby forcing the sphere 202 against the sensor die 206, which will eventually will switch the sensor switch 122 thereby signaling the existence of an occlusion. The occlusion occurs if the pressure generated in the pumping chamber is not released by flow of the feed to be pumped.

FIG. 9b shows a variant of the embodiment of FIG. 9a in which an additional protective cover 210 is interdisposed between the tube 12 and the sphere 202.

As already mentioned above, FIG. 13 shows a controller 150 comprising a memory 152 and a controller interface 154, which controller interface 154 may be a user interface and/or a wirelessly interface for use in combination with e.g. a hand held control unit such as a mobile phone. The controller 150 may be contained in the pump unit 24 or may be contained in a separate controller housing connected with said pump unit 24 by wires 160 or wirelessly.

While the basic concept of pumping with the described embodiment has been explained above, the embodiment of the present invention provides further operational modes, which will be described hereinafter.

The embodiment is able to purge the discharged tube 12 and the volume of feed contained in the pumping cartridge as the operation of the feeding system 2 is terminated. Such purging will reduce the amount of liquid feed, which will have to be discharged in the discharge tube and in the pumping cartridge, which are both disposable and thus would not be used for feeding the patient.

At the end of feeding a batch of liquid feed with the feeding system 2, the purge valve 83 is activated by the purge valve actuator 82 which is driven by a separate purge valve motor 212 provided within the drive unit 24 by means of the controller 150—see FIG. 13. The controller continues to drive the piston 94 and the inlet and outlet valve actuators 100, 102. In other words, volumetric pumping yield is maintained. Each volume per stroke of the piston 94 is stored in the memory 152 of the controller. As the valve arm 84 is provided in the purging position (compare FIG. 7), air is introduced into the pumping channel 62, which air drives the liquid feed contained downstream of the purge inlet 68. As the pump is still activated, the remaining volume of liquid feed is advanced towards the outlet end 16 of the discharged tube 12. Here, the purge sensor 18 will notify arrival of the air in the lumen of the discharge tube 12 and will give a signal indicative of the presence of air to the controller 150. In view of this signal, the controller 150 will stop the pumping activity of the pumping cartridge 22.

Feeding of patient may require different sets of tubing with different tubing length and/or different lumen. Depending on the pumping yield, a different pumping cartridge may be connected to the drive unit 24. In other words, the user may select specific components to assemble the feeding system 2, wherein each of the respective components may have a different specific volume accounting to the flow path of the liquid feed from the reservoir 4 to the outlet end 16. Respective volume may be entered manually by transferring respective information from the package of each of the component. Alternatively, the packaging may contain a barcode, which can be used to read respective information electronically into the memory 152. With this information, the memory 152 can calculate or at least assess the overall volume of the flow path downstream of the purge inlet 68. Knowing the volumetric yield of each stroke of the piston 94, the controller 150 can calculate the number of strokes to purge or almost fully purge remaining liquid feed contained in the fluid path downstream of the purge valve 83.

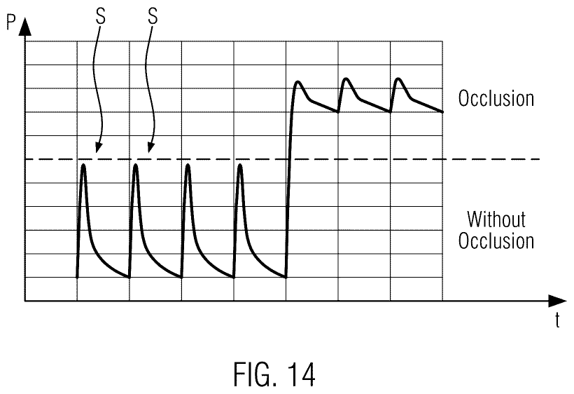

The number of strokes may be counted by the controller 150. Alternatively or additionally, the signal of the occlusion sensor 118 may be used to count the number of strokes in the controller 150. As evident from FIG. 14, each stroke S of the piston 94 will result in a specific pressure signal obtained by the occlusion sensor 18, which signal can be used to count the strokes.

The last three strokes in FIG. 14 correspond to a signal of the occlusion sensor 118 obtained at the incident of an occlusion downstream of the pumping chamber 52. A high pressure builds up which is noted by the occlusion sensor 118 and which is reported to the controller 150 to release a signal indicative of an occlusion. For example, the controller 150 may release an acoustic and/or optical warning notifying the user of the feeding system 2 that liquid feed is not advanced towards the patient as intended.

The above described memory 152 containing and/or receiving information on the specific volume of a specific component may likewise be used as a priming memory 158 for a priming sequence. Such a priming sequence may be initiated by the user via the user interface, which could e.g. comprise a priming button 162. The priming volume stored within the priming memory 158 corresponds to the volume of the feeding system 2, which shall be filled at least downstream of the outlet opening 46 of the pumping cartridge 22 and may as already described for the purge volume, in addition to the feed volume, which can be contained in the pumping cartridge 22 in particular in case multiple cartridge components may be used for assembling the feeding system 2. Knowing the overall volume, which needs to be primed, the controller can activate the pump in the priming sequence and control the priming sequence such that the pumping device 10 is activated to pump the predetermined priming volume of the liquid.

The priming sequence will fill the tubing with liquid feed before actually starting feeding of the patient. The priming sequence reduces the amount of air delivered to the patient when the pumping device 10 is activated at the beginning of supplying a batch of liquid to the patient. Thanks to the priming sequence, feeding of a patient can be started if at least almost the entire feeding system up to the outlet end 16 has been filled with liquid feed.

In addition or alternatively to the calculation of the priming volume described above, the priming sensor 20 may be adapted to identify the presence of liquid which approaches the outlet end 16 and drives air out of the discharge tube 12. Thus, the priming sensor 20 may provide a signal indicative of the presence of the liquid at the outlet end 16 and thereby stop the priming sequence by stopping the pumping device 10.

The purge sensor 18 and/or the priming sensor 20 can be any sensor for example an optical, sonic or temperature sensor, which sensor is located near or at the outlet end 16 to send a signal to the pumping device 10 to automatically stop the priming sequence or the purging phase.

### REFERENCE SIGNS

2 feeding system
4 reservoir
6 bag
8 supply tube
10 pumping device
12 discharge tube
14 inlet end
16 outlet end
18 purge sensor
20 priming sensor
22 pumping cartridge
24 drive unit
26 cartridge housing
28 first housing element
30 second housing element
32 membrane
34 first sandwiching surface
36 second sandwiching surface
38 receptacle
40 boss
42 sealing groove
43 sealant
44 inlet port
46 outlet port
48 sealed membrane area
50 outer surface
52 pumping chamber
54 upstream pumping channel section
56 downstream pumping channel section
58 occlusion sensor chamber
60 occlusion sensor location
62 pumping channel
64 contours
66 purge chamber
68 purge inlet
70 air inlet
72 pumping actuator opening
74 inlet valve actuator opening
76 outlet valve actuator opening
78 occlusion sensor opening
80 cartridge interface
82 purge valve actuator
83 3-way-purge valve
84 valve arm
86 purge chamber outlet opening
88 purge chamber feed inlet opening
90 purge chamber purge inlet opening
92 pumping actuator
94 piston
96 volume varying means
98 drive unit housing
100 inlet valve actuator
102 outlet valve actuator
104 inlet valve location
106 outlet valve location
108 drive interface
110 drive side pumping actuator opening
112 drive side inlet valve actuator opening
114 drive side outlet valve actuator opening
116 drive side occlusion sensor opening
118 occlusion sensor
120 sensor contact element
121 sensor die
122 sensor switch
124 inlet valve
126 outlet valve
128 first motor
130 piston cam
132 piston cam receptacle
134 second motor
136 shaft
138 bearing
140 inlet valve cam
142 inlet valve cam receptacle
144 outlet valve cam
146 outlet valve cam receptacle
150 controller
152 memory
154 controller interface
156 volume flow assessment means
158 priming memory
160 wire
162 priming button
200 sensor clamp
202 sphere
204 sensor housing
206 sensor die
208 arrow
210 protective cover
212 purge valve motor

We claim:

1. A method for operating a feeding system for feeding a patient with a liquid feed, which liquid feed is stored in a reservoir, which reservoir is fluidically connected to a tube which has an inlet end for receiving the liquid feed from the reservoir and an outlet end for dispensing the liquid feed toward the patient and is adapted to convey said liquid feed contained in the reservoir to the patient, and a pumping device adapted to convey the liquid feed from the reservoir through the tube to the patient, wherein at the end of the feeding a controller orders a purging phase in which the supply of the liquid feed from the reservoir is stopped and a purging fluid is introduced into the tube via a purge inlet, which purging fluid drives liquid feed contained in the tube toward the outlet end,
wherein the controller determines the volume of purging fluid to be pumped through the tube on the basis of
a prescribed volume of feed to be supplied to the patient and
a feeding volume of feed supplied to the patient during feeding preceding the purging phase, and
a purging volume essentially corresponding to the volume of the tube or the volume of the liquid feed contained in the feeding system downstream of the purge inlet,
so that the feeding volume and the purging volume correspond to the prescribed volume.

2. The method for operating a feeding system of claim 1, wherein the pumping device is a volumetric pumping device and controller further determines the purging volume on the basis of the volumetric yield of the pumping device.

3. The method for operating a feeding system of claim 2, wherein the pumping device can deliver basic volumes of fluid and the volumetric yield of the pumping device is determined on the basis of the number of basic volumes deliverable by the pumping device.

4. The method for operating a feeding system of claim 1, wherein information on the volume of the tube is stored in a memory of the controller and/or is read into the memory when setting up the feeding system.

5. The method for operating a feeding system of claim 1, wherein the controller stops purging as soon as the determined volume of purging fluid or the prescribed volume has been introduced into the tube.

6. The method for operating a feeding system of claim 1, wherein the tube is selected among a variety of tube and/or metering components, wherein information on the volume of each tube and/or metering components is stored in a memory of the controller and wherein the information on the volume of the selected tube and/or metering component is used for determining the volume of the liquid feed contained at least in part in the feeding system as a result of entry of data identifying the selected tube and/or metering component.

7. The method for operating a feeding system of claim 1, wherein at the beginning of the purging phase the controller controls a purge valve to shut the fluid connection between the reservoir and the outlet end and wherein the controller orders to bring a purge inlet in fluid communication with said tube to allow the purging fluid be introduced into the tube downstream of said purge valve to drive the residual volume of liquid feed toward the outlet end.

8. The method for operating a feeding system of claim 1, wherein the controller determines the end of the purging phase on the basis of a signal of a purge sensor assigned to the outlet end and adapted to detect the presence of the purge fluid within the tube.

9. The method for operating a feeding system of claim 1, wherein the controller stops feed delivery before starting purging.

10. The method for operating a feeding system of claim 1, wherein the purging fluid is air or sterile water.

11. A method for operating a feeding system for feeding a newborn with a liquid feed, which liquid feed is stored in a reservoir, which reservoir is fluidically connected to a tube which has an inlet end for receiving the liquid feed from the reservoir and an outlet end for dispensing the liquid feed toward the newborn and is adapted to convey said liquid feed contained in the reservoir to the newborn, and a pumping device adapted to convey the liquid feed from the reservoir through the tube to the newborn, wherein at the end of the feeding a controller orders a purging phase in which the supply of the liquid feed from the reservoir is stopped and a purging fluid is introduced into the tube, which purging fluid drives liquid feed contained in the tube toward the outlet end and wherein the controller stops the introduction of the purging fluid at the end of the purging phase.

12. The method for operating a feeding system of claim 11, wherein at the beginning of the purging phase the controller controls a purge valve to shut the fluid connection between the reservoir and the outlet end and wherein the controller orders to bring a purge inlet in fluid communication with said tube to allow the purging fluid be introduced into the tube downstream of said purge valve to drive the residual volume of liquid feed toward the outlet end.

13. The method for operating a feeding system of claim 12 wherein the controller determines the end of the purging phase on the basis of the volumetric yield of the pumping device and the volume of liquid feed contained in the feeding system downstream of the purge inlet.

14. The method for operating a feeding system of claim 13 wherein the controller determines the volume of the liquid feed contained in the feeding system downstream of the purge inlet on the basis of information relating to the volume of the tube, which information is stored in a memory of the controller and/or is read into the memory when setting up the feeding system.

15. The method for operating a feeding system of claim 14 wherein the tube is selected among a variety of tube components, wherein information on the volume of each tube component is stored in a memory of the controller and wherein the information on the volume of the selected tube component is used for determining the volume of the liquid feed contained in the feeding system as a result of entry of data identifying the selected tube component.

16. The method for operating a feeding system of claim 12, wherein the controller determines the end of the purging phase on the basis of a signal of a purge sensor assigned to the outlet end and adapted to detect the presence of the purge fluid within the tube.

17. A feeding system for feeding a patient with a liquid feed, comprising a liquid feed reservoir, a tube in fluid communication with said reservoir, which tube has an inlet end for receiving the liquid feed and an outlet end for dispensing the liquid feed toward the patient, a pumping device adapted to convey the liquid feed from the reservoir through the tube to the patient and a controller for controlling operation of the pumping device, wherein the feeding system further comprises a purge inlet which can be brought in fluid communication with the tube, wherein the controller is adapted to control a purging phase in which the supply of the liquid feed from the reservoir is stopped and a purging fluid is allowed to be introduced via the purge inlet into the tube, which purging fluid drives liquid feed contained in the tube toward the outlet end, wherein the controller determines the volume of purging fluid to be pumped through the tube on the basis of
a prescribed volume of feed to be supplied to the patient and
a feeding volume of feed supplied to the patient during feeding preceding the purging phase, and
the purging volume essentially corresponding to the volume of the tube or the volume of the liquid feed contained in the feeding system downstream of the purge inlet,

18. The feeding system according to claim 17, further comprising a three-way-purge-valve, which valve is adapted to be moved into a pumping position in which the reservoir is in fluid communication with the outlet end and a purging position in which the purge inlet is in fluid communication with the outlet end.

19. The feeding system according to claim 17, wherein the pumping device comprises a pumping cartridge having cartridge housing having a pumping chamber, an inlet port and an outlet port, each of said ports being in fluid communication with said pumping chamber via a pumping channel provided within said cartridge housing, and wherein the pumping cartridge further comprises the purge inlet and a purge chamber arranged upstream of the pumping chamber and provided with the purge valve.

20. The feeding system according to claim 17, wherein said purge inlet is an air inlet provided on the outer side of the pumping cartridge.

21. The feeding system according to claim 17, further comprising different components to be connected between the reservoir and the outlet end, wherein the controller comprises a memory adapted to store fluid volumes of the different components and wherein the controller is adapted to determine the volume of the liquid feed contained in the feeding system downstream of the purge inlet on the basis of information identifying the selected component.

22. The feeding system according to claim 17, further comprising a purge sensor assigned to the outlet end and in data communication with said controller and adapted to detect the presence of the purge fluid within the tube.
